(19) United States
(12) Patent Application Publication
(10) Pub. No.: US 2006/0066758 A1
(43) Pub. Date: Mar. 30, 2006

(54) Remote control apparatus and TV broadcast receiving apparatus

(75) Inventor: Morio Higashihara, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/234,287

(22) Filed: Sep. 26, 2005

(30) Foreign Application Priority Data
Sep. 27, 2004 (JP) 2004-279919

(51) Int. Cl. H04N 5/44; G08C 19/00

(52) U.S. Cl. 348/734; 340/825.69

(57) ABSTRACT

An input switch key in a remote controller is a single key for switching video input, and can be selectively operated between + side and − side. When the input switch key is operated to the + side, it can cyclically select broadcast→video 1→video 2→video 3→video 4 in the forward direction, and when the input switch key is operated to the − side, it can cyclically switch video 4→video 3→video 2→video 1→broadcast in the reverse direction, thereby improving operability.

### CROSS-REFERENCE TO RELATED APPLICATIONS

This application is based upon and claims the benefit of priority from prior Japanese Patent Application No. 2004-279919, filed Sep. 27, 2004, the entire contents of which are incorporated herein by reference.

### BACKGROUND OF THE INVENTION

1. Field of the Invention

The present invention relates to a TV broadcast receiving apparatus for receiving, for example, digital TV broadcast, and a remote control apparatus (referred to as remote controller below) for operating the same.

2. Description of the Related Art

As is well known, TV broadcast has been increasingly digitalized in recent years. For example, in Japan, terrestrial digital broadcast as well as satellite digital broadcast such as broadcasting satellite (BS) digital broadcast and 110 communication satellite (CS) digital broadcast has been started.

In a digital broadcast receiving apparatus for receiving such digital TV broadcast, a large-capacity digital recording device such as a hard disk drive (HDD) is connected thereto, so that received programs can be digitally recorded or recorded programs can be reproduced.

Furthermore, at present, a plurality of digital recording devices are connected to one digital broadcast receiving apparatus to be networked, so that the digital broadcast receiving apparatus can instruct an arbitrary digital recording device to record a program or can instruct an arbitrary digital recording device to reproduce a program.

The digital broadcast receiving apparatus can be connected with a plurality of external devices such as a video tape recorder (VTR), a digital versatile disk (DVD) recorder, game equipment, and a BS decoder for pay-TV, which can reproduce video signals or audio signals output from these external devices.

In the digital broadcast receiving apparatus which enables network connection of several digital recording devices or connection of several external devices, it is important that a user can easily manage programs recorded in each digital recording device to rapidly retrieve and reproduce a desired recorded program, and it is required that the user can easily select a connected external device. Thus, the user operates a remote controller to perform various operations such as search and selection.

For example, in order to select the above-described external device, an “input switch” key is generally provided to sequentially switch for each operation like broadcast→video 1→video 2→video 3→video 4→broadcast. However, when one “input switch” key is provided like this, the number of times of operation for selecting an input from a desired external device is increased. Thus, when the user erroneously passes a target input (for example, the user operates until video 3 although he/she wanted to select video 2), he/she cannot return to the start and requires to continue the operation for selecting the target input.

Thus, there is an apparatus in which a plurality of input select keys corresponding to the number of times of input of the external device (for example, four keys corresponding to video 1, video 2, video 3 and video 4) are provided in a remote controller to directly select an input (see Japanese Patent No. 3210560). However, addition of several keys causes a problem that the size of the remote controller becomes larger to give the user an impression of being complicated.

### BRIEF SUMMARY OF THE INVENTION

According to one aspect of the present invention, there is provided a remote control apparatus for operating a TV broadcast receiving apparatus into which signals from a plurality of external devices are input, comprising: a single input switch key configured to select any one of a plurality of signals including the signals from the external devices, wherein the input switch key is configured to have a first operating unit to sequentially select any one of the plurality of signals in a first direction and a second operating unit to sequentially select any one of the plurality of signals in a reverse direction from the first direction.

According to another aspect of the present invention, there is provided a TV broadcast receiving apparatus into which signals from a plurality of external devices are selectively input, comprising: a signal selecting circuit configured to select and output any one signal from among a plurality of input signals including first video and audio signals based on a received broadcast signal and video and audio signals from the plurality of external devices; a remote controller comprising a single input switch key to select any one of the plurality of input signals, the input switch key being configured to have a first operating unit to sequentially select the plurality of input signals in a first direction and a second operating unit to sequentially select the same in a reverse direction from the first direction; a controller configured to control the signal selecting circuit in response to an operation of the first or second operating unit in the input switch key, to cyclically select the plurality of input signals in the first or second direction, and to, when an operation has not been performed for a predetermined time after the operation of the first or second operating unit, output a signal selected immediately before the operation stop from the signal selecting circuit; and reproducing units configured to reproduce video and audio signals selected and output from the signal selecting circuit.

### BRIEF DESCRIPTION OF THE SEVERAL VIEWS OF THE DRAWING

FIG. 1 is a diagram showing one embodiment of the present invention, and is shown for explaining one example of a network system constructed around a TV broadcast receiving apparatus and a remote control apparatus;

FIG. 2 is a block configuration diagram for explaining a main signal processing system in the TV broadcast receiving apparatus according to the embodiment;

FIG. 3 is an appearance view for explaining the remote control apparatus in the TV broadcast receiving apparatus according to the embodiment;

FIG. 4 is a flowchart for explaining an input selecting operation in an analog system in the TV broadcast receiving apparatus according to the embodiment;

FIG. 5 is a view for explaining one example of an input switch screen in the analog system in the TV broadcast receiving apparatus according to the embodiment;

FIG. 6 is a flowchart for explaining an operation in which the TV broadcast receiving apparatus according to the embodiment causes a digital recording device to record a program;

FIG. 7 is a flowchart for explaining an operation in which the TV broadcast receiving apparatus according to the embodiment causes the digital recording device to reproduce a program;

FIG. 8 is a view for explaining one example of a navigation menu displayed during the reproducing operation in the TV broadcast receiving apparatus according to the embodiment; and

FIG. 9 is a view for explaining one example of a display screen of a list of recorded programs obtained from the navigation menu according to the embodiment.

### DETAILED DESCRIPTION OF THE INVENTION

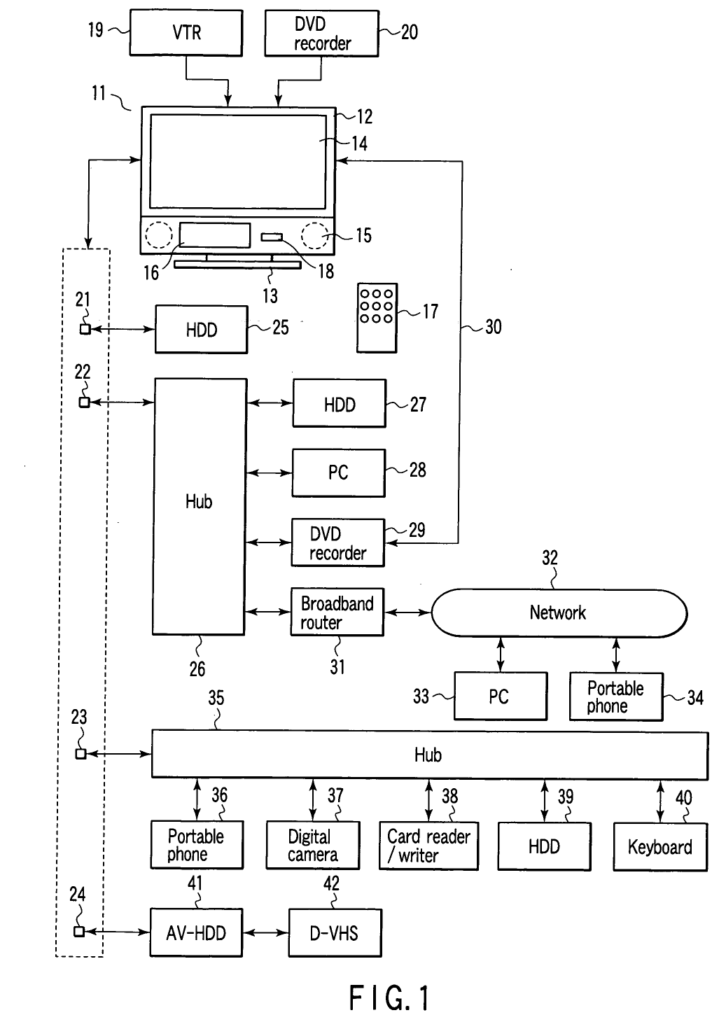

One embodiment of the present invention will be described below in detail with reference to the drawings. FIG. 1 schematically shows an appearance of a digital TV broadcast receiving apparatus 11 explained in this embodiment, and one example of a network system constructed around the digital TV broadcast receiving apparatus 11.

Specifically, the digital TV broadcast receiving apparatus 11 mainly comprises a thin cabinet 12 and a support 13 for supporting the cabinet 12 in a standing manner. The cabinet 12 is provided with a flat-panel-shaped video display 14 made of, for example, a liquid crystal display panel, a speaker 15, an operating unit 16, and a light receiving unit 18 for receiving operation information transmitted from a remote controller 17.

The digital TV broadcast receiving apparatus 11 is provided with a plurality of input terminals (input terminals of video or audio signal) to which external devices such as a VTR 19 and a DVD recorder 20 can be connected, where a video signal or audio signal supplied from the external devices can be reproduced. Although the VTR 19 or DVD recorder 20 is exemplified as the external device, other devices such as game equipment and high definition multimedia interface (HDMI) can be connected thereto.

Besides, the digital TV broadcast receiving apparatus 11 has an attachable/detachable memory card such as a secure digital (SD) card, a multimedia card (MMC), a memory stick or IC card, and information such as programs or photographs can be recorded in/reproduced from the memory card.

The digital TV broadcast receiving apparatus 11 comprises a first local area network (LAN) terminal 21, a second LAN terminal 22, a universal serial bus (USB) terminal 23 and an i.Link terminal 24.

The first LAN terminal 21 is used as a LAN-capable HDD-only port, which is used for recording/reproducing information through Ethernet (trademark) into/from a LAN-capable HDD 25 as a connected network attached storage (NAS).

As described above, the first LAN terminal 21 as the LAN-capable HDD-only port is provided, so that program information can be stably recorded in high vision quality in the HDD 25 without being influenced by other network environment or network use status.

The second LAN terminal 22 is used as a typical LAN-capable port using Ethernet, which is used for connecting devices such as a LAN-capable HDD 27, a personal computer (PC) 28 and a HDD-incorporated DVD recorder 29 via, for example, a hub 26 and for performing information transmission with these devices.

Since digital information communicated via the second LAN terminal 22 is information only for control system, the DVD recorder 29 requires to be provided with a dedicated analog transmission path 30 for transmitting analog video and audio information with the digital TV broadcast receiving apparatus 11.

The second LAN terminal 22 is used for connecting to a network 32 such as Internet via a broadband router 31 connected to the hub 26 and performing information transmission with a PC 33 or a portable phone 34 via the network 32.

The USB terminal 23 is used as a typical USB-capable port, which is used for connecting a portable phone 36, a digital camera 37, a card reader/writer 38 for a memory card, a HDD 39, a keyboard 40 and the like via, for example, a hub 35 and for performing information transmission with these devices. Further, the i.Link terminal 24 is used for serially connecting, for example, an AV-HDD 41, a D (digital)-VHS (video home system) 42 and the like and for performing information transmission with these devices.

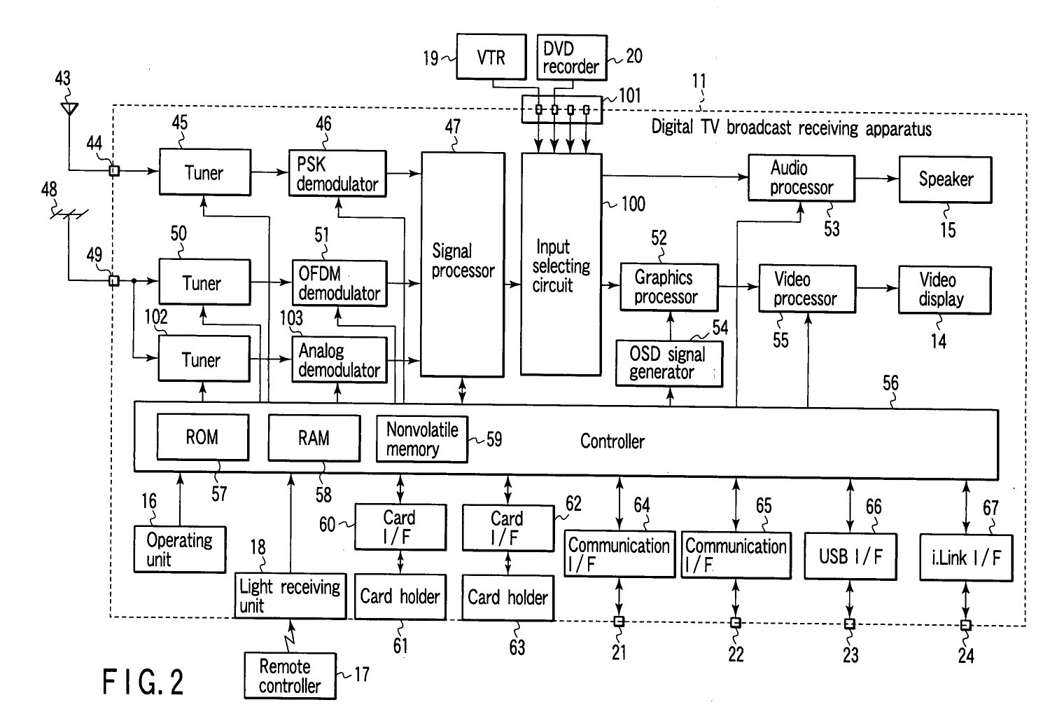

FIG. 2 shows a main signal processing system in the digital TV broadcast receiving apparatus 11. Specifically, a satellite digital TV broadcast signal received at a BS/CS digital broadcast receiving antenna 43 is supplied to a satellite digital broadcast tuner 45 via an input terminal 44, so that a broadcast signal of a desired channel is selected.

The broadcast signal selected in this tuner 45 is supplied to a phase shift keying (PSK) demodulator 46, and is demodulated into digital video signal and audio signal to be output to a signal processor 47.

A terrestrial digital TV broadcast signal received at a terrestrial broadcast receiving antenna 48 is supplied to a terrestrial digital broadcast tuner 50 via an input terminal 49, so that a broadcast signal of a desired channel is selected.

The broadcast signal selected in this tuner 50 is supplied to an orthogonal frequency division multiplexing (OFDM) demodulator 51, and is demodulated into digital video signal and audio signal to be output to the signal processor 47.

The antenna 48 is connected with a tuner 102 for analog terrestrial TV broadcast signal, so that a broadcast signal of a desired channel is selected. The analog broadcast signal selected by the tuner 102 is demodulated into analog video signal and audio signal in an analog demodulator 103 and is then output to the signal processor 47.

The signal processor 47 selectively performs predetermined digital signal processing on the digital video signal and audio signal supplied from, for example, the PSK demodulator 46 and the digital video signal and audio signal supplied from the OFDM demodulator 51, and further converts the digital video signal into an analog video signal in the format which can be displayed in the video display 14. It converts the input digital audio signal into an analog audio signal in the format which can be reproduced by the speaker 15. Then, it selectively outputs the analog video signal and the analog audio signal corresponding to any one of the broadcast signals received at each tuner 45, 50 or 102 and supplies the same to an input selecting circuit 100.

The video signal and audio signal from the input selecting circuit 100 are output to a graphic processor 52 and an audio processor 53. The graphic processor 52 has the function of superimposing an OSD signal generated in an on-screen display (OSD) signal generator 54 on the video signal supplied from the signal processor 47 and outputting the obtained signal. The graphic processor 52 can selectively output the video signal and the OSD signal, or can combine and output both the signal outputs to constitute half the screen.

The digital video signal output from the graphic processor 52 is output to the video display 14 via the video processor 54, so that the video is reproduced. The selected audio signal is output to the speaker 15 via the audio processor 53, so that the audio is reproduced.

The input selecting circuit 100 is supplied with video and audio signals from the external device such as the VTR 19 or the DVD recorder 20 via an input terminal group 101. The input selecting circuit 100 is directed for selecting and outputting any one input signal of a plurality of input signals including the video and audio signals based on the broadcast signal from the signal processor 47 and the video and audio signals from the external devices, where any one input signal is selected and output in response to an operation of the remote controller 17 and the selected video signal is output to the video display 14 to be displayed.

In the digital TV broadcast receiving apparatus 11, various operations including various receiving operations described above are entirely controlled by a controller 56. The controller 56 is a microprocessor incorporating a central processing unit (CPU) and the like, which receives operation information from the operating unit 16 or receives operation information sent from the remote controller 17 via the light receiving unit 18 and controls each unit such that the operation contents are reflected.

In this case, the controller 56 has a read only memory (ROM) 57 which stores therein a control program executed by the CPU, a random access memory (RAM) 58 for providing a work area for the CPU, and a nonvolatile memory 59 which stores therein various items of setting information and control information.

The controller 56 is connected to card holders 61 and 63 via card interfaces (I/F) 60 and 62. These card holders 61 and 63 are attachable with the aforementioned memory card. Thus, the controller 56 can perform information transmission with the respective memory cards attached on the card holders 61 and 63 via the card I/F's 60 and 62.

The controller 56 is connected to the first LAN terminal 21 via a communication I/F 64. Thus, the controller 56 can perform information transmission with the LAN-capable HDD 25 connected to the first LAN terminal 21 via the communication I/F 64. In this case, the controller 56 has the dynamic host configuration protocol (DHCP) server function, and controls by assigning an internet protocol (IP) address to the LAN-capable HDD 25 connected to the first LAN terminal 21.

The controller 56 is connected to the second LAN terminal 22 via a communication I/F 65. Thus, the controller 56 can perform information transmission with each device (see FIG. 1) connected to the second LAN terminal 22 via the communication I/F 65.

The controller 56 is connected to the USB terminal 23 via a USB I/F 66, and can perform information transmission with each device (see FIG. 1) connected to the USB terminal 23 via the USB I/F 66.

Further, the controller 56 is connected to the i.Link terminal 24 via an i.Link I/F 67, and the controller 56 can perform information transmission with each device (see FIG. 1) connected to the i.Link terminal 24 via the i.Link I/F 67.

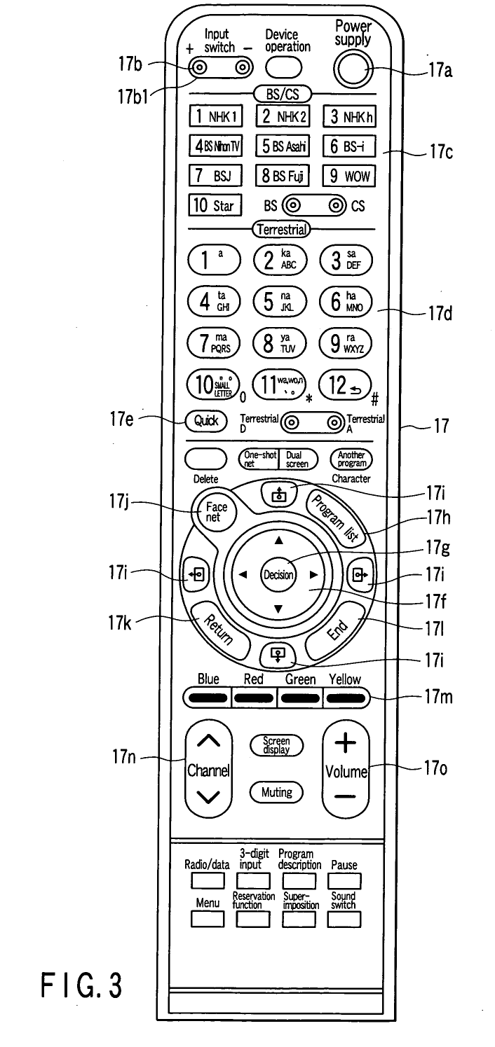

FIG. 3 shows an appearance of the remote controller 17. The remote controller 17 is mainly provided with a power supply key 17a, a seesaw-shaped input switch key 17b, a satellite digital broadcast channel direct select key 17c, a terrestrial broadcast channel direct select key 17d, a quick key 17e, a cursor key 17f, a decision key 17g, a program list key 17h, page switch keys 17i, a face net (navigation) key 17j, a return key 17k, an end key 17l, color keys 17m of blue, red, green and yellow, a channel up/down key 17n, a volume adjust key 17o and the like.

Next, various functions executable through the operation of the remote controller 17 will be described. First, video input switching in the analog system will be described. This is directed for determining which input signal to select and output through the user's operation, where the analog system video input can be switched by operating the input switch key 17b in the remote controller 17.

The input switch key 17b can be selectively operated between + side and − side, and has a seesaw structure in which a midpoint between an operating unit 17b1 at the + side and an operating unit 17b2 at the − side is assumed as a fulcrum. Signs or graphics (in FIG. 3, signs of + and −) representing forward direction and reverse direction are denoted near the + side operating unit 17b1 and the − side operating unit 17b2.

When the input switch key 17b is operated to the + side, the video input is selectively switched in a cyclical manner in the forward direction like video 1→video 2→video 3→video 4→video 5→HDMI→broadcast. When the input switch key 17b is operated to the − side, the video input is switched in a cyclical manner in the reverse direction like HDMI→video 5→video 4→video 3→video 2→video 1→broadcast. Since only cyclical switching in the forward direction was possible conventionally, it was inconvenient for the user. But, the cyclical switching in the reverse direction is added, thereby improving operability.

In the video input switching through the input switch key 17b, there is employed a system in which only the OSD display is switched in a state in which the input switch key 17b is continuously pressed, and the display is switched to a selected input screen after the operation has been stopped for a predetermined time. Thus, it eliminates a complexity in which the screen is frequently changed each time the input switch key 17b is operated.

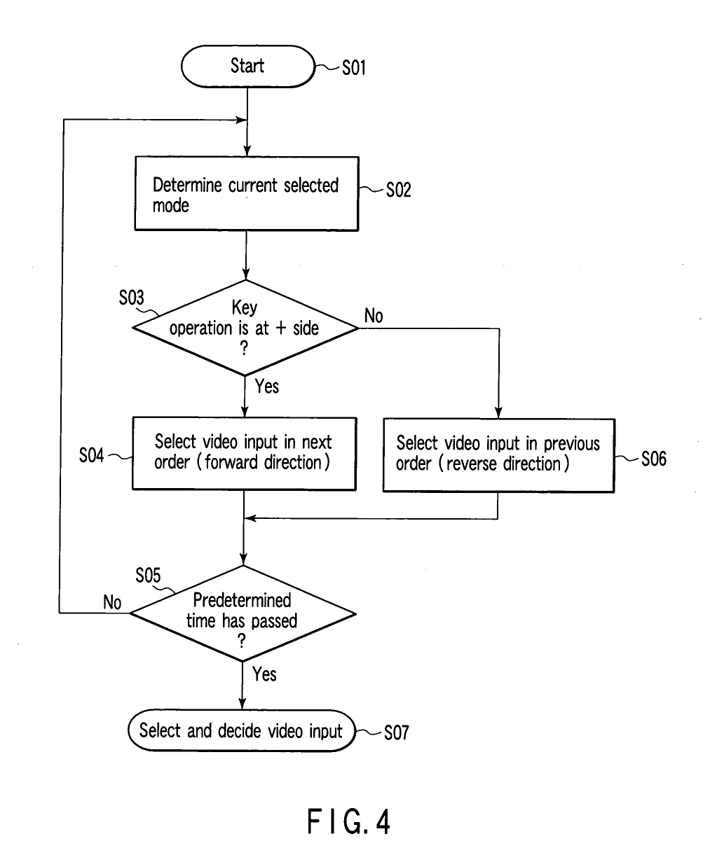

FIG. 4 is a flowchart of the input selecting operation through the operation of the input switch key 17b. Specifically, when the input switch processing is started (step S01), the controller 56 determines a currently selected input in step S02, and determines in step S03 whether the input switch key 17b has been operated to the + side or the − side.

When the input switch key 17b is operated to the + side and, for example, broadcast is selected at present, the processing proceeds to step S04 to select video 1 in the forward direction. Further, the controller 56 determines in step S05 whether key operation is being continued. When the key is operated to the + side continuously or within a short time, the processing returns to step S02 and circulates step S03→S04→S05→S02, and sequentially selects video 1→video 2→video 3→video 4→video 5→HDMI in the forward direction. In step S05, if key operation has not been performed within a predetermined time after the stop of the operation of the input switch key 17b, the input select mode is determined at that time (step S07).

When it is determined in step S03 that the input switch key 17b has been operated to the − side, the processing proceeds to step S06 to perform input selection to the previous order, that is, in the reverse direction. When the − side is operated continuously or within a short time, the processing returns to step S02 via step S05, circulates step S03→S06→S05→S02, and sequentially selects broadcast→HDMI→video 5→video 4→video 3→video 2→video 1 . . . in the reverse direction. Further, when the key operation has not been performed for a predetermined time in step S05, the input select mode is determined at that time (step S07). Therefore, the cyclical switching in the reverse direction as well as the cyclical switching in the forward direction is added, thereby improving operability.

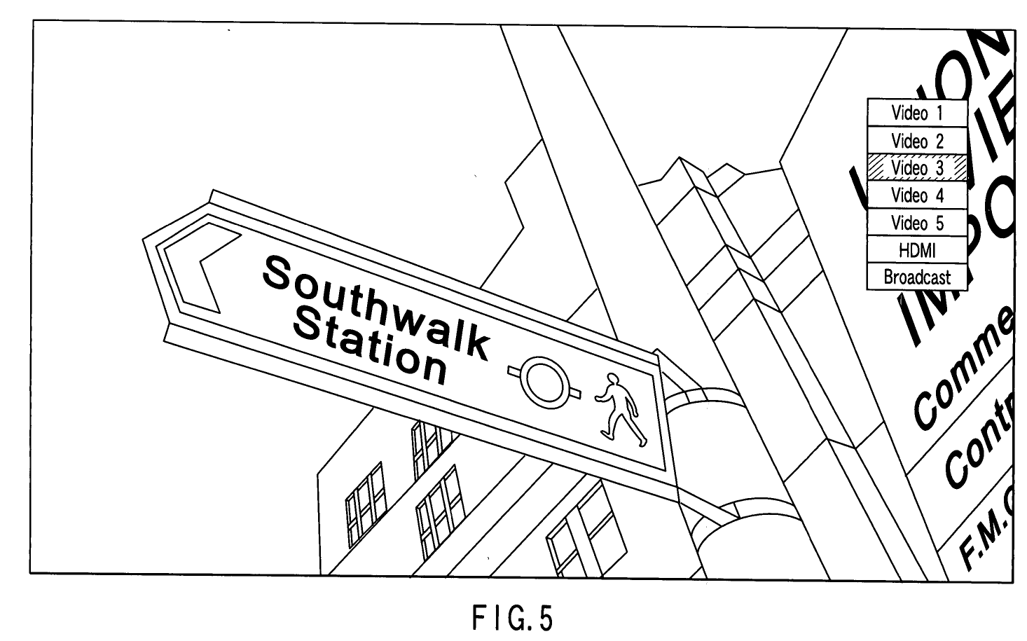

In video input conversion through the input conversion key 17b, the switching status of the video input terminal is OSD-displayed on the display screen of the video display 14 as shown in FIG. 5. FIG. 5 shows an example in which video 3 is selected as shown with diagonal lines.

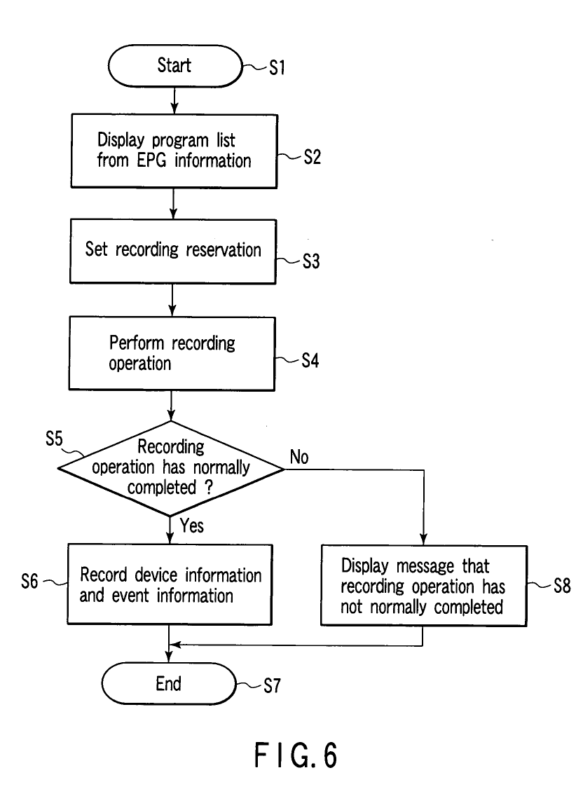

Next, FIG. 6 is a flowchart for explaining an operation in which the digital TV broadcast receiving apparatus 11 records a program in a digital recording device among the respective devices connected to the terminals 21 to 24.

Specifically, when the processing is started in response to a program recording request (step S1), the controller 56 displays a program list on the video display 14 based on electronic program guide (EPG) information obtained from the broadcast signal. Then, the user performs recording reservation setting of a desired program based on the displayed program list in step S3. In the recording reservation setting, a program to be recorded is selected from the program list and a digital recording device to record the program is selected and set.

When the recording-reserved setting time is reached in step S4, the controller 56 performs recording operation to record the reserved program in the reservation-set digital recording device.

Thereafter, the controller 56 determines in step S5 whether the program recording operation has normally completed. When it is determined that is has normally completed (YES), in step S6 the controller 56 records device information (device ID, device name, common holder name and the like) for specifying the digital recording device which has performed recording and event information (event ID, channel number, title, contents explanation, genre, recording range, image quality mode and the like) relating to the recorded program in the nonvolatile memory 59, and terminates the processing (step S7).

When it is determined in step S5 that the program recording operation has not normally completed (NO), the controller 56 displays a message that the program recording operation has not normally completed on the video display 14 in step S8, and terminates the processing (step S7).

With the above recording operation, the user can arbitrarily select a plurality of digital recording devices connected to each terminal 21 to 24 in the digital TV broadcast receiving apparatus 11 to record a program therein.

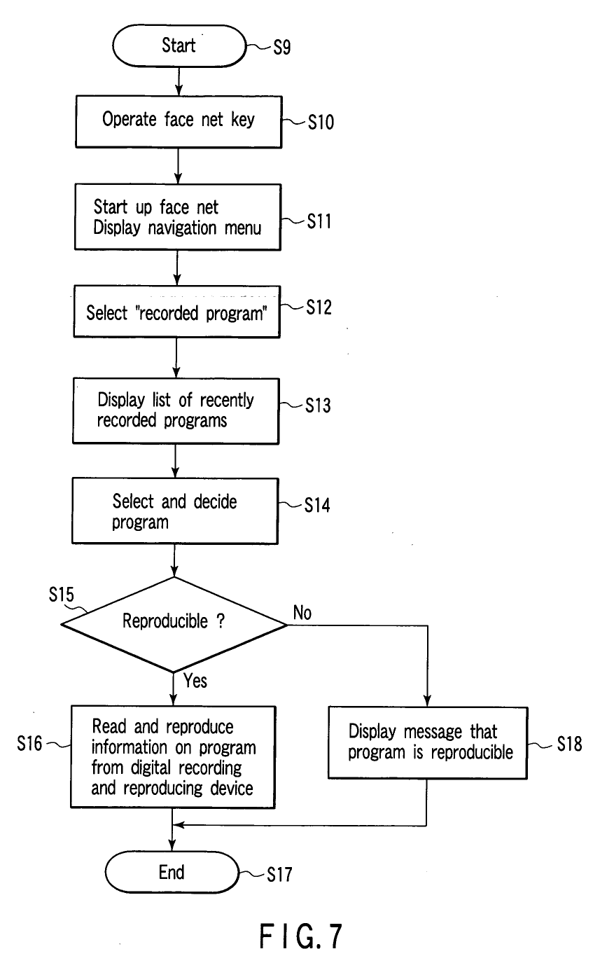

Furthermore, FIG. 7 is a flowchart for explaining an operation of rapidly retrieving a desired program from among various programs recorded in a plurality of digital recording devices and reproducing the same. Specifically, when the processing is started (step S9), the user operates the face net key 17j in the remote controller 17 in step S10.

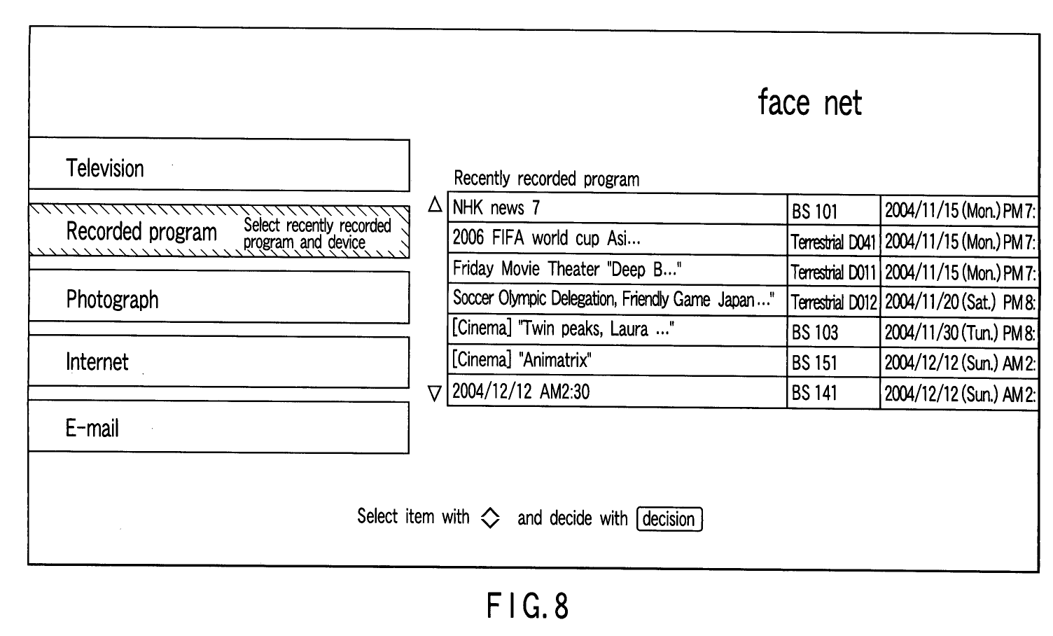

Then, the controller 56 starts up the face net (navigation) in step S11, and displays the navigation menu on the video display 14. Five items such as “TV”, “recorded program”, “photograph”, “Internet” and “e-mail” are selectably provided in the navigation menu as shown in FIG. 8.

When any one item is selected by the cursor key 17f, the selected item is displayed on the screen with different color from other items. When it is assumed that the user operates the cursor key 17f in the remote controller 17 and selects the item of “recorded program” in step S12, the controller 56 enters the state in which the item of “recorded program” is selected as shown with hatching in FIG. 8.

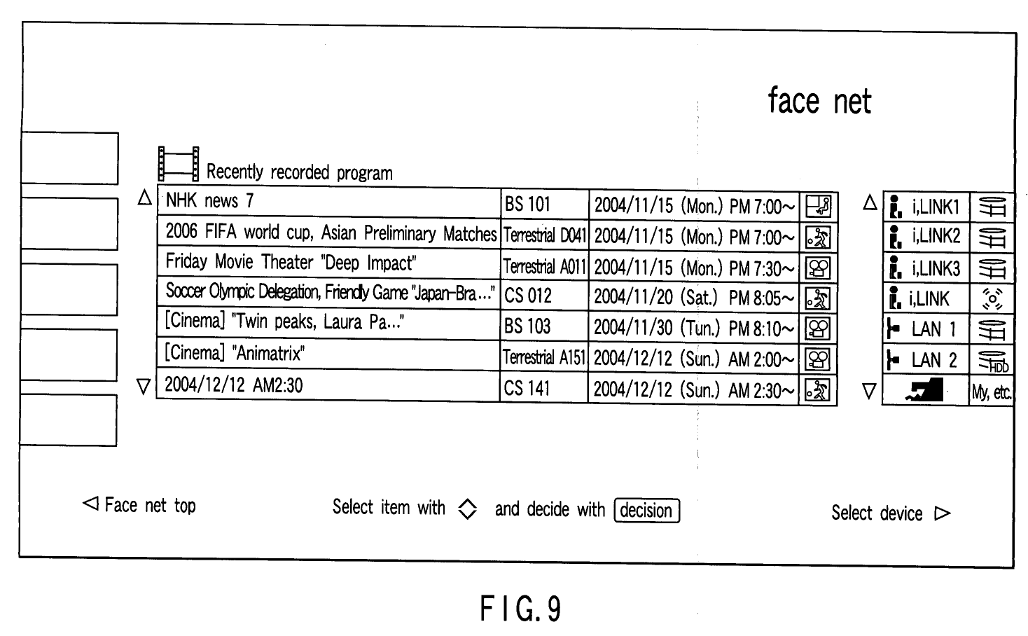

When the user operates the decision key 17g in the remote controller 17 in step S13 in this state, the controller 56 displays a list of recently recorded programs on the video display 14 as shown in FIG. 9. In the program list, there are displayed information representing recorded programs such as title, broadcast channel, recording date, day of the week, time, genre and the like.

The list of recently recorded programs is created by referring to the device information for specifying the digital recording device which has performed recording and the event information relating to the recorded programs, which are recorded in the nonvolatile memory 59 in reserving and recording the program. In the list of recently recorded programs, for example, 35 programs before the latest recorded program can be displayed in 5 units by 7 programs irrespective of the digital recording device which has performed recording.

Although FIG. 9 shows a list of 7 programs, the list of 35 programs can be viewed by scrolling the display through the operation of the cursor key 17f. When the page switch key 17i in the remote controller 17 is operated, the 7 programs displayed in the list can be skipped at one time.

When the user selects information representing a desired program from the list of recently recorded programs by operating the cursor key 17f in the remote controller 17 and decides the same by operating the decision key 17g in step S14, the controller 56 specifies the digital recording device in which the selected and decided program is recorded, and determines whether the program is reproducible from the information recorded in the nonvolatile memory 59 in step S15.

The determinations are made as to whether the digital TV broadcast receiving apparatus 11 and the digital recording device which records therein a reproduction-requested program are connected, as to whether the digital recording device which records therein the reproduction-requested program is powered on, and as to whether the program is still recorded in the target digital recording device by comprehensively comparing various conditions in recording and in reproducing.

When it is determined in step S15 that the program is reproducible (YES), the controller 56 controls to read the information on the reproduction-requested. program from the target digital recording device and to reproduce the same, and terminates the processing (step S17).

When it is determined in step S15 that the program is not reproducible (NO), the controller 56 displays a message that the requested program is not reproducible on the video display 14 in step S18, and terminates the processing (step S17).

According to the above reproducing operation, since the apparatus has the navigation function of displaying the list of programs before the latest recorded program, the user can easily manage the programs recorded in a plurality of digital recording devices, and can rapidly retrieve and reproduce a desired program from among the programs displayed in the list by selecting it by the cursor key 17f and deciding it by the decision key 17g.

Further, the digital TV broadcast receiving apparatus 11 has the photograph reproducing function. Specifically, when the item of “photograph” is selected and decided from the navigation menu displayed in FIG. 8, which is displayed by operating the face net key 17j in the remote controller 17, a plurality of photographs recorded in a memory card (not shown) attached on the card holder 61 can be displayed in a list, for example.

The digital TV broadcast receiving apparatus 11 periodically determines the incoming status of e-mail with respect to the connected PCs 28 and 33, and when e-mail has reached, the apparatus can display an incoming message such as “3 e-mails arrived” on the display screen of the video display 14. When the decision key 17g in the remote controller 17 is operated in the state in which the incoming message is being displayed, the e-mail information can be displayed on the video display 14. Alternatively, also when the item of “e-mail” is selected and decided from the navigation menu shown in FIG. 8, a desired PC 28 or 33 can be designated to transmit e-mail or to read the arrived e-mail.

The page switch key 17i in the remote controller 17 is operated, so that the video displayed on the screen of the video display 14 can be switched by the page. Specifically, the cursor key 17f in the remote controller 17 is composed of four keys corresponding to the upper, lower, left and right directions in order to move the cursor in the upper, lower, left and right directions on the screen. The page switch keys 17i are composed of four keys corresponding to the four cursor keys 17f.

For example, when the page switch key 17i corresponding to the cursor key 17f for moving the cursor in the upper direction is operated, the current display screen is switched into a video present at the upper side of the screen. The page switching function enables to rapidly select a desired screen as compared with scrolling the screen by operating the cursor key 17f.

Since the page switch keys 17i are arranged in correspondence to the cursor keys 17f, the moving direction can be easily recognized. The screen which can be switched by the page switch keys 17i is, for example, a list of recently recorded programs shown in FIG. 8.

Specifically, as shown in FIGS. 8 and 9, the function items such as “recorded program” are displayed in a list in a predetermined unit (navigation display), the cursor keys 17f are directed for sequentially selecting any one item from the items displayed in the list, and the page switch keys 17i are directed for skip-selecting an item in another unit. Since the cursor keys 17f have operating units at regular interval in the horizontal and vertical directions around the decision key 17g, and the page switch keys are arranged therearound in correspondence to the positions of the respective operating units, the displayed page can be skipped by the page switch key 17i in the same direction as the direction indicated by the cursor key 17f.

In this manner, in the above embodiment, the digital TV broadcast receiving apparatus having many functions can be made preferable in its operability and can be provided with a user-friendly remote controller.

The present invention is not limited to the above embodiment, and may be implemented by modifying constituents without departing from the spirit in implementation. Further, appropriate combinations of several constituents disclosed in the above embodiment can form various inventions. For example, several constituents may be deleted from all the constituents shown in the embodiment. Moreover, constituents over different embodiments may be appropriately combined.

What is claimed is:

1. A remote control apparatus for operating a TV broadcast receiving apparatus into which signals from a plurality of external devices are input, comprising:
a single input switch key configured to select any one of a plurality of signals including the signals from the external devices,
wherein the input switch key is configured to have a first operating unit to sequentially select any one of said plurality of signals in a first direction and a second operating unit to sequentially select any one of said plurality of signals in a reverse direction from the first direction.

2. A remote control apparatus according to claim 1, wherein the input switch key is configured to have a seesaw structure in which a midpoint between the first operating unit and the second operating unit is assumed as a fulcrum.

3. A remote control apparatus according to claim 1, wherein signs or graphics representing the first and second directions are added near the first operating unit and the second operating unit in the input switch key.

4. A TV broadcast receiving apparatus into which signals from a plurality of external devices are selectively input, comprising:
a signal selecting circuit configured to select and output any one signal from among a plurality of input signals including first video and audio signals based on a received broadcast signal and video and audio signals from said plurality of external devices;
a remote controller comprising a single input switch key to select any one of said plurality of input signals, the input switch key being configured to have a first operating unit to sequentially select said plurality of input signals in a first direction and a second operating unit to sequentially select the same in a reverse direction from the first direction;
a controller configured to control the signal selecting circuit in response to an operation of the first or second operating unit in the input switch key, to cyclically select said plurality of input signals in the first or second direction, and to, when an operation has not been performed for a predetermined time after the operation of the first or second operating unit, output a signal selected immediately before the operation stop from the signal selecting circuit; and
reproducing units configured to reproduce video and audio signals selected and output from the signal selecting circuit.

5. A TV broadcast receiving apparatus according to claim 4, wherein the input switch key is configured to have a seesaw structure in which a midpoint between the first operating unit and the second operating unit is assumed as a fulcrum.

6. A TV broadcast receiving apparatus according to claim 4, wherein signs or graphics representing the first and second directions are added near the first operating unit and the second operating unit in the input switch key.

7. A TV broadcast receiving apparatus according to claim 4, wherein the reproducing units comprise a display to display a video signal, and are configured to display a type of a signal cyclically selected during operation of the first or second operating unit in the input switch key on the display based on the control of the controller.

8. A remote control apparatus for controlling a display configured to display a navigation menu which displays a plurality of function items in a list every predetermined unit, comprising:
a decision key;
a cursor key configured so that a plurality of selection operating units are arranged at regular interval around the decision key; and
page switch keys configured to be arranged in correspondence to the positions of the respective operating units of the cursor key around the same, wherein
any one item from items displayed in a list is sequentially selected through an operation of the cursor key and an item in another unit is skip-selected by the page switch key.
